(19) United States
(12) Patent Application Publication
(10) Pub. No.: US 2001/0022758 A1
(43) Pub. Date: Sep. 20, 2001

(54) Pill storage, dispensing and notification device

(75) Inventor: David H. Howard, Tampa, FL (US)

Correspondence Address: Jeffrey H. Kamenetsky, Esq., Malin, Haley & DiMaggio, P.A., 1936 South Andrews Avenue, Fort Lauderdale, FL, 33316, US

(73) Assignee: MICHAEL HABER

(21) Appl. No.: 09/760,866

(22) Filed: Jan. 12, 2001

Related U.S. Application Data
(63) Continuation-in-part of application No. 09/056,207, filed on Apr. 7, 1998, now abandoned.

(51) Int. Cl. G04B 47/00; G04F 10/00

(52) U.S. Cl. 368/10; 340/309.4; 368/107; 368/278; 368/109

(57) ABSTRACT

An apparatus for storing, dispensing and alerting a patient when to take a prescribed medication is provided having a housing in the form of a pager for enclosing a plurality of medication compartments stored therein. Each of the compartments houses a plurality of different medications usually in pill or tablet form. Each modular compartment is separated by one or more removable dividers that allow the user to alter the size and orientation of each compartment. The apparatus further contains an information screen for giving the patient vital information about what medication to take, how to access the appropriate compartment, and when to take it. Special alarms prevent the patient from taking the wrong medication at un-prescribed times. Programming buttons allow the apparatus to be programmed to that patient's specific medicinal needs.

### CROSS-REFERENCE TO RELATED APPLICATIONS

This application is a continuation-in-part of Ser. No. 09/056,207, filed on Apr. 7, 1998.

### BACKGROUND OF THE INVENTION

1. Field of the Invention

Generally, this invention is directed toward an apparatus for pharmaceutical medications. More specifically, this invention relates to an improved pill dispenser for storing, dispensing, concealing, and alerting a patient when to take his/her medication.

2. Description of Related Art

Generally, when a doctor prescribes a medication for a patient, the prescription is to be taken specifically as directed by the doctor (i.e. the dosage, and number of times per day are to be followed exactly as prescribed by the doctor). If the patient follows the procedure for taking the medication rigidly, it allows the doctor to more accurately determine if the medication is working properly, or to vary the dosage and medication. The problem arises when a patient neglects to follow the doctor's prescribed medication procedure and continues to remain ill. This problem makes it difficult for a doctor to ascertain whether the original medication was working or to prescribe different medications and dosages. Thus, a device needs to be integrated with prescription drugs that will allow a patient to more accurately follow the doctor's prescribed medication. Another problem with prescription drugs is the inconvenience of carrying around a plurality of prescription bottles. This is not only cumbersome, but embarrassing as well. Therefore, a device that can carry a plurality of medications in an easy and inconspicuous manner would also be beneficial to patients.

Several approaches have been provided for pill dispensers and the like. For example, U.S. Pat. No. 4,962,491, describes a portable medicament dispenser and patient medical information storage apparatus that utilizes a housing containing external access to an alpha/numeric keyboard, a visual display having a clock display, an alpha/numeric display portion, and a plurality of control function keys which may be used to enter the name of medicaments and the times that they should be taken throughout the day, coupled to a memory storage mechanism. An audio device enunciates the time in which all of the medicament, in bulk quantity and contained within a compartment of the apparatus, may be retrieved by the user. A cover, over the compartment, opens automatically at the times that any medicaments are taken by the user, who then selects those medicaments he is to take at that time. By programming the keyboard, patient information may be inserted into the storage mechanism, for use during emergencies. A stationary device, similarly equipped with an alpha/numeric display and keyboard coupled to a storage mechanism may be used to program the portable device at the source where medicaments are dispensed. An output terminal of the stationary device may simultaneously print labels for the dispenser.

In the art taught by Stone, U.S. Pat. No. 4,798,309, a programmable machine for dispensing items, such as pills or capsules, in timed sequence is described. The machine includes a cylindrical container element provided with a series of item receiving and dispensing compartments extending spirally there along and opening into its circumferential surface for alignment with a discharge opening in a stationary cylindrical shell within which the container element is mounted for both rotary and axial movement concentrically over and along a microprocessor controlled, stepper motor, so as to sequentially bring the individual compartments into precise alignment with the discharge opening of the shell to discharge their contents into a delivery tray. The containment element is mounted or on and along a stationary spiral track-way as it is rotated. The compartments may be filled by turning the machine upside down and inserting items through the discharge opening.

U.S. Pat. No. 4,768,177 teaches a device for indicating when medication should be taken, having plural compartments, each of which may store medication. An electrical signaling system emits signals from time to time, each of which indicates (a) that medication should be taken; (b) from which compartment the medication should be taken; and (c) the quantity of medication to be taken from the designated compartment, and instructions for taking the medication.

While some of the prior art may contain some similarities relating to the present invention, none of them teach, suggest or include all of the advantages and unique features of a pill storage dispensing, concealing, and paging apparatus that can store and dispense a plurality of medications, alert the patient when and how much medication to take, and conceal the medication in an inconspicuous manner as presented by the applicant's invention.

### BRIEF SUMMARY OF THE INVENTION

The present invention is directed towards a medication or pill storage, dispensing, concealing, and alerting apparatus for patients. In the preferred embodiment, the invention consists of a watertight housing having a plurality of medication compartments stored therein for enclosing a plurality of medications normally in pill form. The apparatus contains generally an information screen with programming buttons that alerts a patient when to take his/her medication, how much medication to take, and what compartment the medication is located. In one embodiment, transmitting and receiving means are located inside the apparatus to allow for the communication of data between the patient and a receiver station. A rear pivoting cover conceals and exposes the plurality of inner medication compartments when closed and opened respectively. Each medication compartment contains a separate corresponding button to open the compartments and communicate with a central processor. A battery power supply and other necessary components are also integrated with the invention.

In an alternate embodiment, the pill storage apparatus is an electronically controlled medication reminder device that resembles a pager, yet includes all of the features of a conventional pill box. No paging features are included in this particular embodiment. The device is small and compact enough to be carried in a pocket, purse or belt clip.

The apparatus can be programmed to match the user's medication needs. The programming function is user-friendly. The user simply enters the time and identity of the medication to be taken at that particular interval.

The housing of the pill storage apparatus is adapted to affix to the user's belt clip and includes an alarm signal to remind user when it is time to take certain medications. The signal alerting the user to take his or her medication can be in the form of an audio signal or a visual signal, or a vibration signal, much like a traditional pager. When the alarm is activated, a visual display shows the reminder information until the user acknowledges it by depressing one of the buttons. During normal operations, the apparatus acts like a clock by displaying the current time.

This preferred embodiment contains up to four modular storage compartments with three dividers therebetween. It is within the spirit of the invention, however, to provide a larger number of compartments, depending upon the size of the pill dispenser housing. The storage compartments are adjustable in size to accommodate different sized pills. Each compartment is revealed by the manual sliding of the top cover with respect to the bottom cover. The top cover slides along the raised walls of the bottom cover and utilizes positive stops or clicks to advise the user that a new compartment, containing medication has been revealed. The housing is completely watertight, includes a digital clock, custom display features and is fully programmable. Due to the slidable relationship between the top and bottom covers, the top cover does not pivot outwards as in the preferred embodiment. Therefore, the apparatus takes up less space when opened.

Accordingly, it is a general object of this invention to provide a pill storage and dispensing device that will store a plurality of medications.

Still another object of this invention is to provide a central processor that will alert a patient when to take his/her medication.

Still yet, another object of this invention is to provide a pill storage and dispensing device that contains a plurality of medication compartments that house a plurality of different medications respectively.

A further object of this invention is to provide a pill storage and dispensing device that contains an information screen to communicate to patient information pertaining to his/her medication.

Another object of this invention is to provide a pill storage dispensing device that will easily dispense medication to a patient when the time to take the prescribed medication has arrived.

Still another object of this invention is to provide a pill storage and dispensing device that will alert the user either by audio, visual, or vibration means when it is time for the medication to be dispensed.

Yet another embodiment is to provide a pill storage and dispensing device that resembles a pager and which contains modular compartments, that are removable and adjustable, thereby increasing or decreasing the size of available storage space within each compartment.

Other objects and a fuller understanding of the invention will become apparent from reading the following Detailed Description of a preferred embodiment in conjunction with the accompanying drawings.

In accordance with these and other objects which will become apparent hereinafter, the instant invention will now be described with particular reference to the accompanying drawings.

### BRIEF DESCRIPTION OF THE SEVERAL VIEWS OF THE DRAWINGS

This invention, together with other objects, features, aspects and advantages thereof, will be more clearly understood fro the following description, considered in conjunction with the accompanying drawings.

Twenty-one sheets of drawings are furnished, sheet one contains FIG. 1, sheet two contains FIG. 2, sheet three contains FIG. 3, sheet four contains FIG. 4, sheet five contains FIG. 5, sheet six contains FIG. 6, sheet seven contains FIG. 7, sheet eight contains FIG. 8, sheet nine contains FIG. 9, sheet ten contains FIG. 10, sheet eleven contains FIG. 11, sheet twelve contains FIG. 12, sheet thirteen contains FIG. 13, sheet fourteen contains FIG. 14, sheet fifteen contains FIG. 15, sheet sixteen contains FIG. 16, sheet seventeen contains FIG. 17, sheet eighteen contains FIG. 18, sheet nineteen contains FIG. 19, sheet twenty contains FIG. 20 and sheet twenty-one contains FIGS. 21-26.

FIG. 1 shows a perspective view of the invention having a generally cubic configuration, a front side having a plurality of programming buttons, and a rear pivoting cover at the back side.

FIG. 2 shows a perspective view of the invention having a generally cubic configuration, a back side having a pivoting cover with an upper latch at the top.

FIG. 3 shows a perspective view of the invention having a generally cubic configuration, with the back pivoting cover completely removed for clarity. A plurality of medication compartments are exposed (four shown) for housing a plurality of medications in pill form. At the upper region is a multiplicity of buttons for opening the medication compartments and for signaling a central processor when that particular compartment has been opened.

FIG. 4 shows a perspective view of the invention having a generally cubic configuration, with the back pivoting cover completely removed for clarity. A single medication compartment is opened fully to expose the top opening thereby allowing a patient to gain access to the medication or pills. Similarly, as in FIG. 3, the upper region contains a multiplicity of buttons for opening the medication compartments and for signaling a central processor. Note, the opened compartment was initiated by button 5.

FIG. 5 shows a side cut-away view of the invention exposing the inner medication compartment in a fully closed position. The mechanism that connects the buttons and medication compartment is also seen in the figure. At the bottom region, a pivoting member is shown for allowing the medication compartment to pivot to an open position relative to the outer compartment.

FIG. 6 shows a side cut-away view of the invention exposing the inner medication compartment in a fully opened position. The mechanism that connects the buttons and medication compartment is shown in a fully depressed position thereby opening the medication compartment. The top opening of the medication compartment is thereby cleared from the outer housing to allow medication or pills to be dispensed.

FIG. 7 shows an exploded side cut-away view of the mechanism portion of the invention exposing more detail. The button is shown in a fully depressed position thereby opening the medication compartment. In addition, an electrical connection is made between the button and central processor, which is indicated by an on LED light.

FIG. 8 is identical to FIG. 7 with the exception that the button is opened and disconnected from the electrical connection.

FIG. 9 shows a top view of the invention giving an audible signal to the patient. The top information screen notifies to the patient which medication to take and out of which medication compartment.

FIG. 10 shows a side view of the invention with the back pivoting cover in a fully closed position.

FIG. 11 shows a side view of the invention with the back pivoting cover in a fully open position.

FIG. 12 shows a top view of the invention with an incoming signal for communicating with the invention. The receiver/transmitter from the pager then communicates with the patient from the top information screen.

FIG. 13 shows a block diagram of the invention and how the primary components communicate with each other.

FIG. 14 shows an exploded view of an alternate embodiment of the invention

FIG. 15 shows a perspective view of the alternate embodiment of the invention wherein the pill dispenser resembles a pager and is in a completely closed position, concealing the storage compartments.

FIG. 16 shows a perspective view of the alternate embodiment of the invention wherein the front cover is slidably drawn back to reveal a storage compartment.

FIG. 17 shows a perspective view of the alternate embodiment of the invention wherein the front cover is further retracted to reveal additional storage compartments.

FIG. 18 shows a block diagram of the electrical components of the alternate embodiment of the present invention.

FIG. 19 shows a logic flowchart of the steps of the alternate embodiment of the present invention.

FIG. 20 shows a logic flowchart of an interrupt routine associated with the flowchart of FIG. 19.

FIG. 21 shows a particular housing configuration of the front face of the present invention including display window and control buttons.

FIG. 22 shows a different housing configuration of the front face of the present invention including display window and control buttons.

FIG. 23 shows a different housing configuration of the front face of the present invention including display window and control buttons.

FIG. 24 shows the configuration of FIG. 21 including LCD display and control buttons.

FIG. 25 shows the configuration of FIG. 22 including LCD display and control buttons.

FIG. 26 shows the configuration of FIG. 23 including LCD display and control buttons.

### DETAILED DESCRIPTION OF THE INVENTION

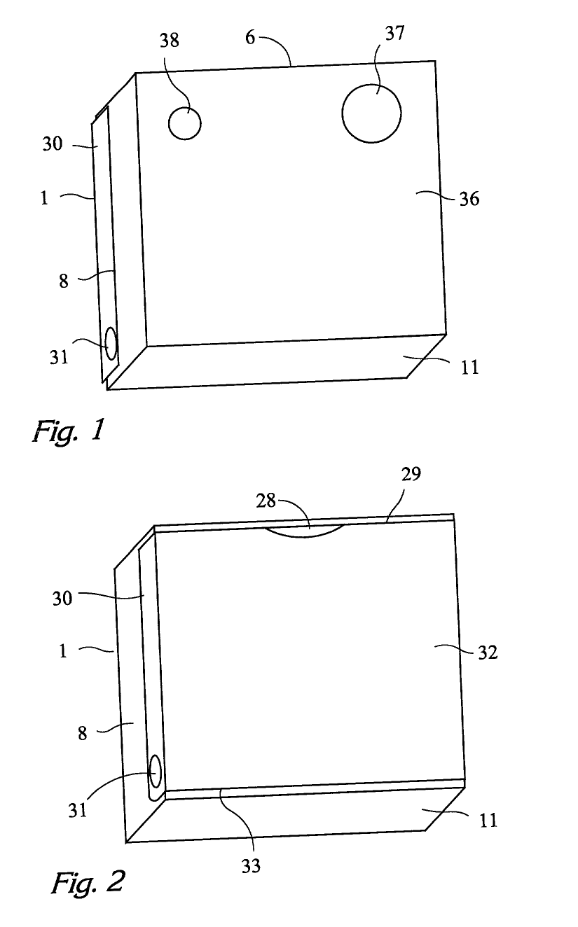

Referring now to FIG. 1, a pill storage device for dispensing pills is referred to generally by reference numeral 1. Note, all the figures show a pager apparatus, however, for concealment purposes, a cellular phone housing could easily replace the pager housing. The main body of the pager is made up primarily of a front side 36, lateral sides 8, a bottom side 11, a top side 6, and a rear side 32 (seen in FIG. 2). The front side of the apparatus 1 contains two programming buttons 37, and 38 for programming the pager and obtaining information from the pager. The 1^{st} and 2^{nd} programming buttons 37, and 38 are commonly used buttons in the industry and are currently used by other pager manufacturers.

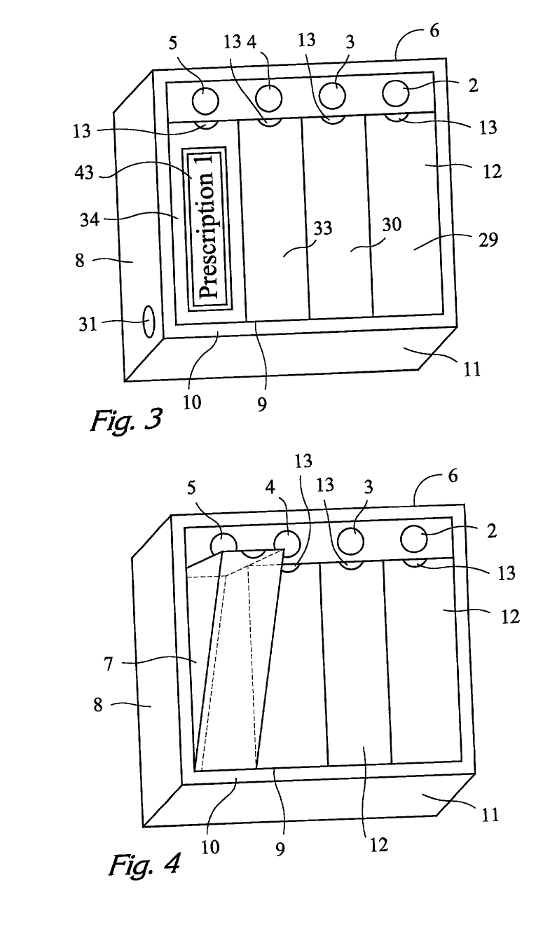

In FIG. 2, at the rear side of the apparatus 1, we see the back side that is made up primarily of a cover 32 that is pivotally affixed to the apparatus 1 via hinges 31. The cover 32 contains a bottom edge 33, a top edge 29, lateral sides 30, and a top handle 28. The cover 32 is pivotally affixed to the pager apparatus 1 to allow the cover 32 to swing away from the apparatus 1 thereby exposing the inner medication compartments 29, 30, 33, and 34, seen in FIG. 3. In FIG. 2, the cover is completely closed. Note, FIG. 11 shows a side view of the cover 32 opened thereby exposing the inner medication compartments 29, 30, 33, 34.

In FIG. 3, we see a view of the back side of the apparatus 1 with the cover 32 completely removed from the figure for clarity. Four medication compartments 29, 30, 33, 34 are shown aligned with each other in a linear fashion. At the top of each pill compartment are release buttons 2-5 to open the medication compartments 29, 30, 33, 34, respectively, and allow the pills inside to be dispensed. Each medication compartment contains a handle or latch 13 affixed near the top side and each compartment is pivotally affixed to the apparatus 1. Note in the figure, one of the medication compartments 29, 30, 33, 34 shows a label 43 for indicating what medication is inside. Note, each compartment 12 may contain specific labels to clarify and separate different medications being stored in the medication compartments 29, 30, 33, 34. The medication compartments 29, 30, 33, 34 are only allowed to pivot about the lower portion where the hinge is located thereby allowing only the top portion is separated from the apparatus as in FIG. 4. This helps prevent the contents of compartments 29, 30, 33, 34 from completed falling out of the apparatus 1 and scattering on the floor.

FIG. 4 shows one of the compartments 29, 30, 33, 34 in a fully open position relative to the apparatus 1 and how the compartment 12 pivots relative to the apparatus 1. The top portion of the compartment 12 is open and the pills are stored and dispensed through this opening 14.

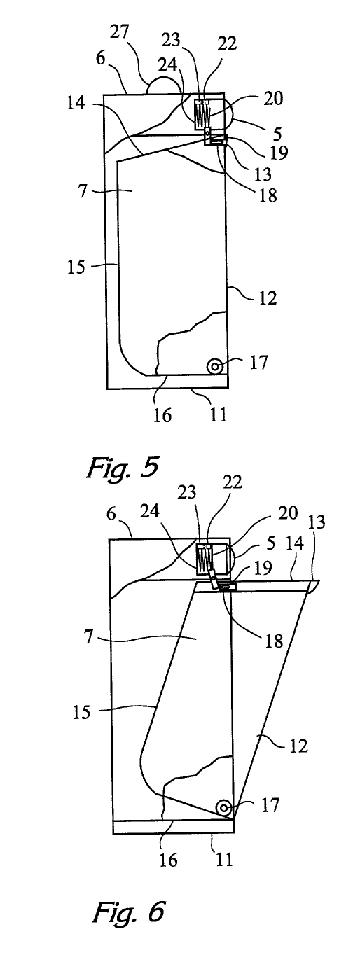

In FIG. 5, we see cutaway views of the apparatus 1 and medication compartments 29, 30, 33, 34 exposing the mechanisms that open the medication compartments 29, 30, 33, 34 and signal the central processor 25 (not shown in this figure) to reset. The compartment 12 contains lateral sides 7, a bottom side 16, hinge assembly 17, a back side 15, a handle 13, and an open top side 14.

The pill compartment is shown being pivotally affixed to the apparatus body via hinge 17. The opening mechanisms generally contain a horizontal sliding member 18, a pivoting member 24, and a hinge 19. The button 5 is shown in a fully released position thereby allowing the medication compartment to be in a fully closed position.

FIG. 6 shows the same view of FIG. 5 except that the button 5 is in a fully depressed position thereby opening the medication compartment to an open position. In the open position, the pill compartment can dispense and store pills through the top opening 14. Note, when the button 5 is fully depressed, it completes a circuit and notifies the central processor 25 that the pill compartment has been opened. It is assumed that the only time the pill compartment is opened is to dispense medication and thus the central processor 25 can record this important information in the memory storage 48.

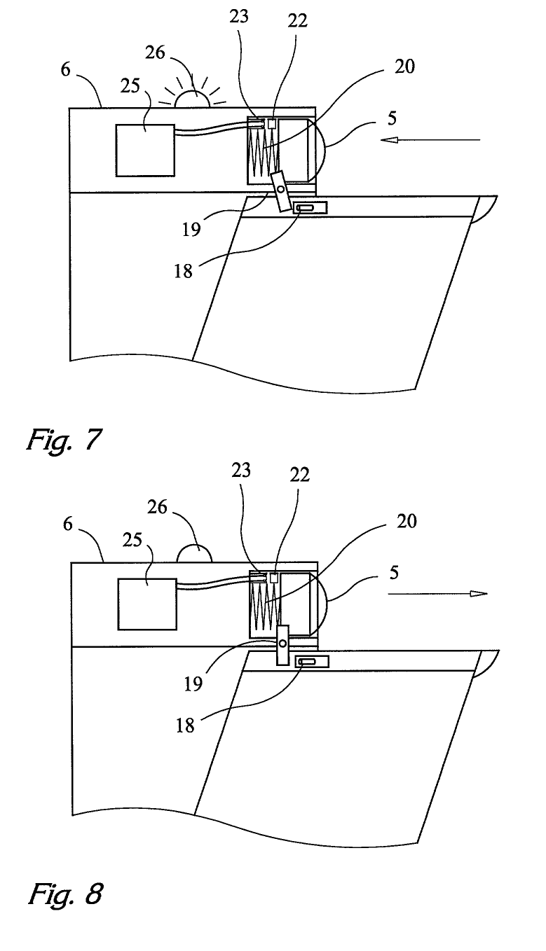

In FIG. 7 and 8, and exploded view of the button 5 is shown in a fully depressed and open position respectively. When the button 5 is depressed, electrical contacts 22, and 23 are connected and an electrical circuit sends a signal to processor 25 to evaluate this information. When the circuit is complete by connecting contacts 22, and 23, the LED light 26 is lit up signaling to the patient that the processor 25 has been notified that the medication compartment has been opened. It can only be assumed that the patient will take his/her medication after opening the medication compartment. Keep in mind that this invention is designed primarily for those patients who are willing to take the doctor's prescribed medication and is only intended to assist and remind the patient when and how much medication to take. FIG. 8 shows the button 5 in an released position thus, contacts 22 and 23 are not connected. Also, the LED light is not on at this time as indicated by number 27. Note, button 5 is spring loaded via spring 20, which returns button 5 to its original position after being depressed. Also note, each time button 5 is pressed, the memory storage 48 (not shown in this figure) records this process for later evaluation.

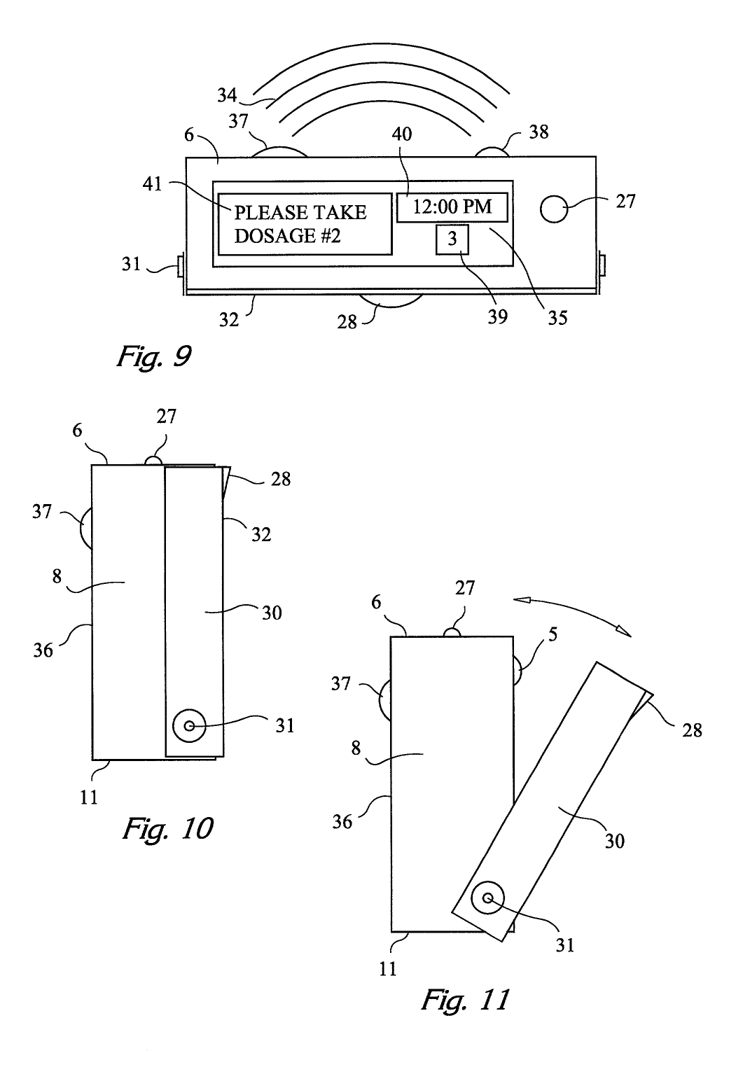

In FIG. 9, we see a top view of the apparatus 1 having an information screen 35 for displaying a multiplicity of information to the patent and doctor. Screen 35 is typically made of a liquid crystal display for low power consumption with at least three windows, one for the prescription compartment 39, one for the time and date 40, and one for general information 41. The top information screen 35 notifies the patient when to take his/her medication or dosage, how much or the amount of dosage to take, and where or which compartment the medication is located. In this figure, an audible signal 34 is shown, informing the patient that it is time to take his/her medication, and what compartment should be opened. In this rd particular case, the 3 medication compartment 33 should be opened via button 4. Note, the signal 34 can be audible, visual, or a vibration, as with ordinary vibrating pagers.

Once the audible signal has sounded the patient can turn off the alarm by pressing any of the programming buttons 37 or 38. Once the proper compartment is opened via button 4, the central processor will reset the time period for the next dosage. Note, if the wrong compartment is opened via buttons 2, 3, or 5, an alarm will sound indicating to the patient that he/she has not opened the proper medication compartment. A patient may not open any of the medication compartments 29, 30, 33, 34 without triggering the alarm if it is not the proper time to take that particular medication. Remember, one of the intentions of this invention is to have the medication taken as prescribed by the doctor. If the wrong compartment is accidentally opened, the patient should close that compartment, deactivate the alarm via programming buttons, and open the proper compartment as indicated on information screen 35. Note, the proper medications stored in the medication compartments 29, 30, 33 and 34 are pre-programmed into the central processor 25 of the pager prior to patient use. Normally, a doctor, nurse, technician or even pharmacist will be trained for this procedure however, a manual can be given to the patient for programming.

If an alarm sounds, the proper procedure to follow is the patient first presses one of the programming buttons to silence the alarm. Next the patient opens the back cover via latch 28 to expose the inner medication compartments. The patient then presses button 4, which corresponds to the 3^{rd} medication compartment 33 as prescribed on the information screen 35. As the patient presses button 4, the LED light 27 is lit up and the compartment 33 opens. Note, the “on” LED light 27 indicates to the patient that the central processor 25 has been electronically notified that the compartment 33 has been opened. The proper dosage of medication is then dispensed through the top opening 14 of the medication compartment 33 and taken by the patient. The compartment 33 is then closed. The central processor 25 has already reset the time period for the next dosage of that particular medication.

FIGS. 10 and 11 show a side view of the back cover 32 and how it is pivotally affixed to the pager. In FIG. 10, the cover 32 is fully closed, which prevents the inner medication compartments form opening or the buttons 2-5 from accidentally being pressed. FIG. 11 shows the cover 32 in the fully open position, whereby the inner medication compartments can be opened by pressing the corresponding buttons 2-5. Note, the back cover 32 is allowed to swing open a given distance that is equal to the distance the inner compartments are allowed to swing open.

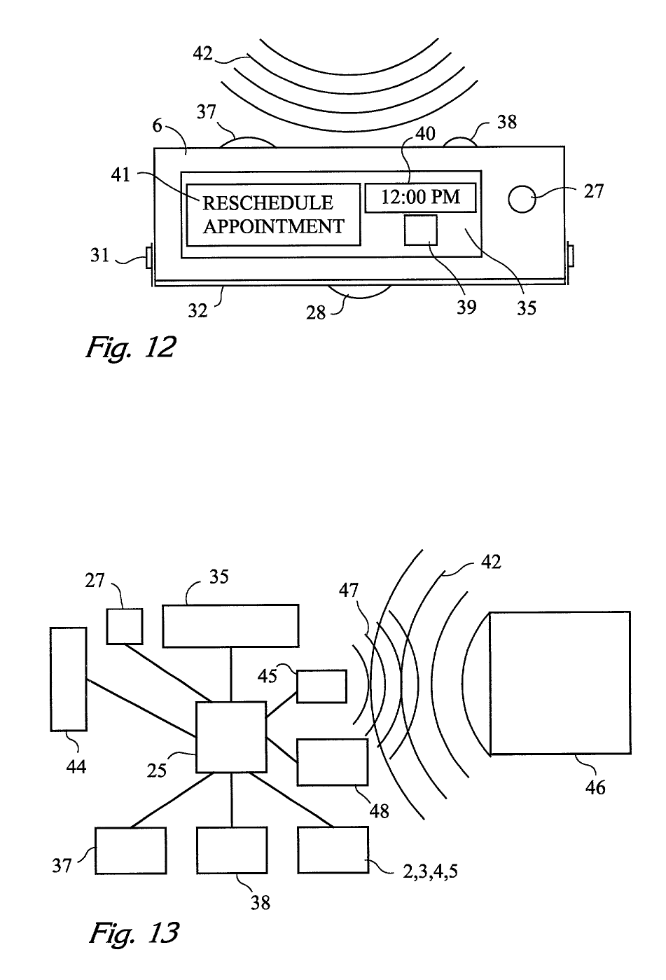

The invention is allowed to communicate with a central station as with conventional pagers. In FIG. 12, an incoming signal 42, is shown communicating with the pager to display a message 41 at the top information screen 35. FIG. 13 shows a block diagram of the primary components of the invention communicating with each other. In FIG. 13, the pager has receiving and transmitting means for communicating information between the pager and a central processing station 45. The receiver/transmitter from the pager communicates information with the patient via the central processor 25 and information screen 35. When the receiving unit of the pager receives a signal, the central processor is notified and the proper information ID displayed onto the information screen 35. The patient is alerted that an incoming message has been received via the indicating signal 34.

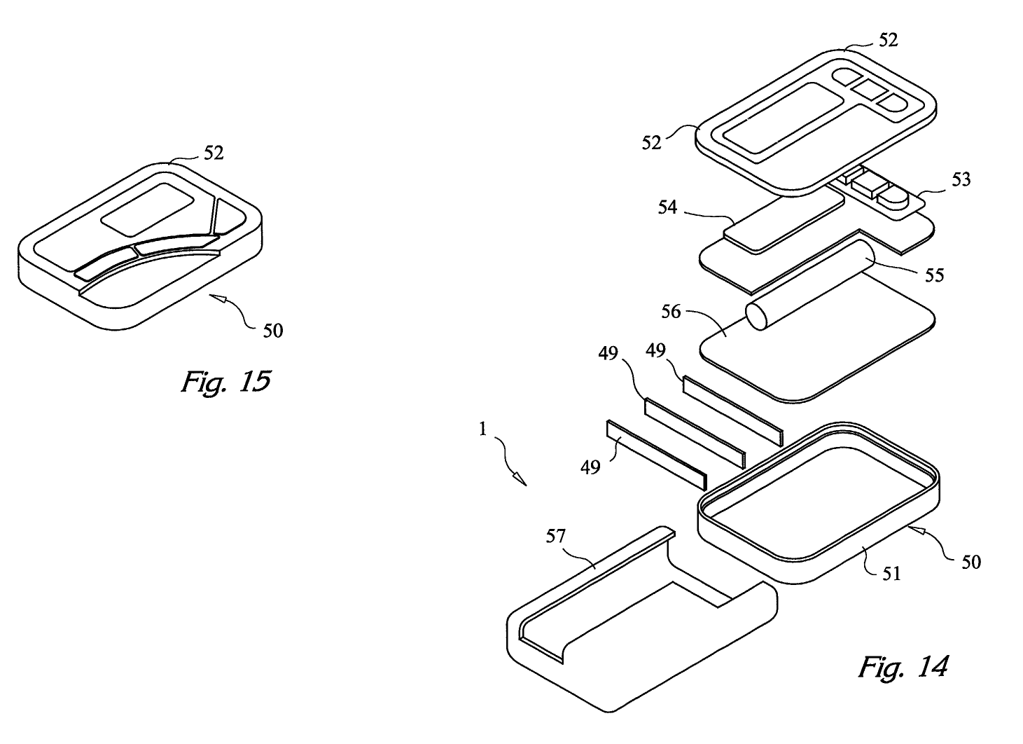

In an alternate embodiment of the present invention, the pill storage apparatus 1 resembles that shown in FIG. 14. In this embodiment, a series of dividers 49 are transversely disposed across the interior of the bottom cover 50. Virtually any number of dividers can be utilized, within the constraints of the bottom cover size. Bottom cover 50 includes raised walls 51 protruding upwards from and around its periphery. A top cover 52 and bottom cover 50 enclose a keypad 53, LCD protection glass 54, battery 55, and back cover 56 which encloses all of the electronics. Although batteries are the preferred power source, alternative power sources can be used. The entire apparatus can be enclosed in a holder 57, which can affix to the user's belt.

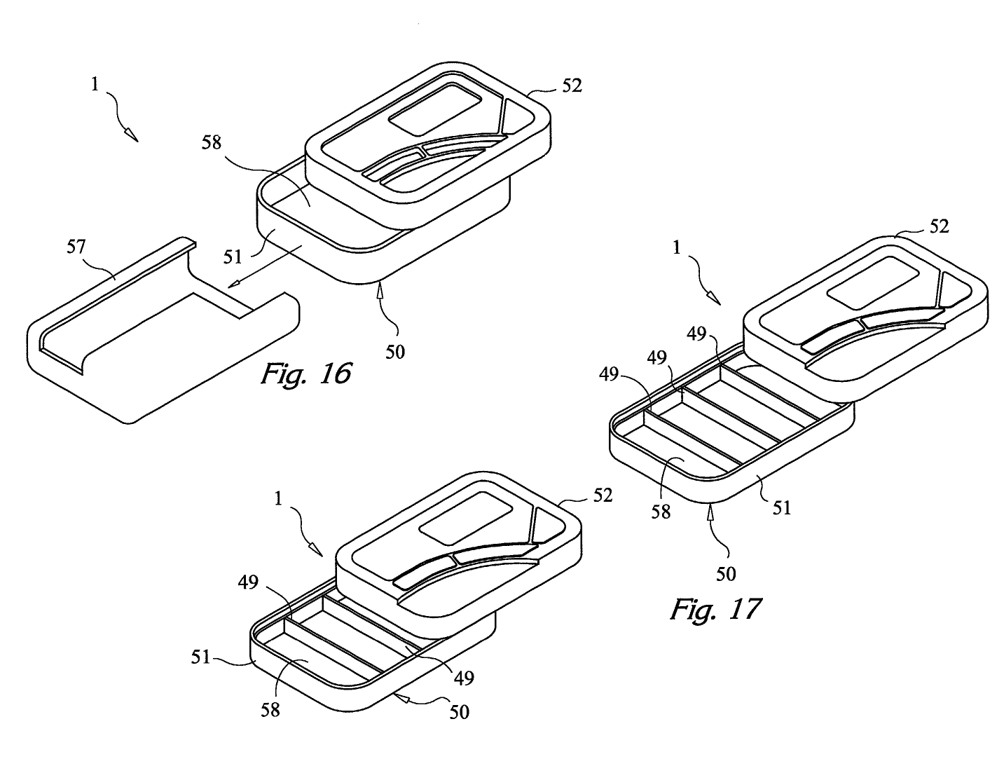

This embodiment includes several unique features. Referring to FIGS. 15 and 16, when the apparatus is in a closed configuration, top cover 52 is substantially flush with bottom cover 50. The entire apparatus can slide into the interior space of holder 57. When the user needs to take his or her medication, top cover 52 slides along the edge of bottom cover 50 to reveal one of the interior compartments within. This can be seen clearly in FIG. 16, as top cover 52 slides along raised walls 51 of bottom cover 50 in the direction of the arrow. A first storage compartment 58 is revealed. As top cover 52 slides along the raised walls of the bottom cover it clicks into a “locked” position to reveal one of the storage compartments.

In FIG. 17, additional compartments are revealed as the apparatus is retracted further along bottom cover 50. Once again, the top cover locks into place after each slidable movement, to reveal another storage compartment. An audible click signifies the completion of the transition. Each compartment can be revealed or concealed in this manner. To reveal another compartment or to close the storage apparatus, front cover 52 is disengaged from its temporary “locked” position and slid either along the direction of the arrow in FIG. 16 to reveal further storage compartments, or in the opposite direction to cover the compartments. After all four compartments are revealed, the top cover cannot retract any further. Preferably, the front and back covers never completely disengage.

Dividers 49 can be removed and re-inserted within the bottom cover interior to create a variety of different-sized medicine storage compartments. Although this embodiment does not include paging features, the pill storage apparatus resembles a pager, and is fully programmable, to allow the user to enter medicine-intake information.

The user is reminded via a reminder signal, to take his or her medication. The reminder signal can be in the form of an audio signal, visual signal such as flashing lights, or a vibrator alarm signal. The audio signal can be a variety of sounds such as a chirping sound, for example; 8 audible chirps every second, for approximately 15 seconds, although virtually any audible signal configuration can be used. The audio signal can be repeated every 15 minutes for an hour or longer, if the user does not acknowledge it. The vibration signal is generally 3 seconds long and can be repeated every 15 minutes for an hour, until the user responds. The user can program information such as which medication to take, the dosage, and how often the medication is to be taken.

The electronics system of the apparatus keeps the current time and alerts the user when it is time to take the medicine. The electronics system is primarily comprised of a display, a microcontroller, batteries, audio alarm and keyboard. The current time is displayed during normal operation. An alarm list can be programmed and stored in non-volatile memory. Upon detection of a match between the current time and the alarm list an alarm signal is produced.

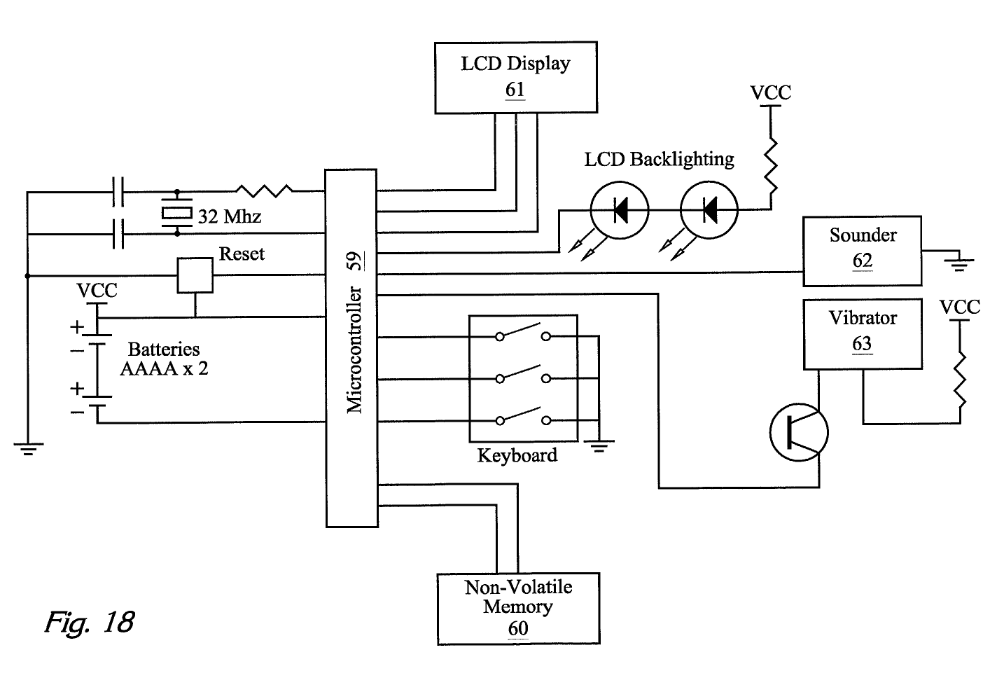

FIG. 18 is a schematic showing the inter-relationship between the electronic components of the present invention. The electronics of the present invention can be controlled with most state-of-the-art processors. Preferably, the apparatus of the present invention is integrated on a host processor such as the Microchip PI16LC54 microcontroller with an 8-bit processor, offering 512 bytes of program memory and 25 bytes of random access memory. A 32 kHz system clock is provided with one counter as an internal timer. 12 I/O ports are available along with interrupts as required. Microcontroller 59 is based upon CMOS technology for low power consumption with selectable oscillator options. Programming is accomplished via use of the C programming language and standard off the shelf software.

Non-volatile memory 60 stores the alarm list. LCD display 61 is controlled by microcontroller 59, which also controls the sounder 62 and vibrator 62.

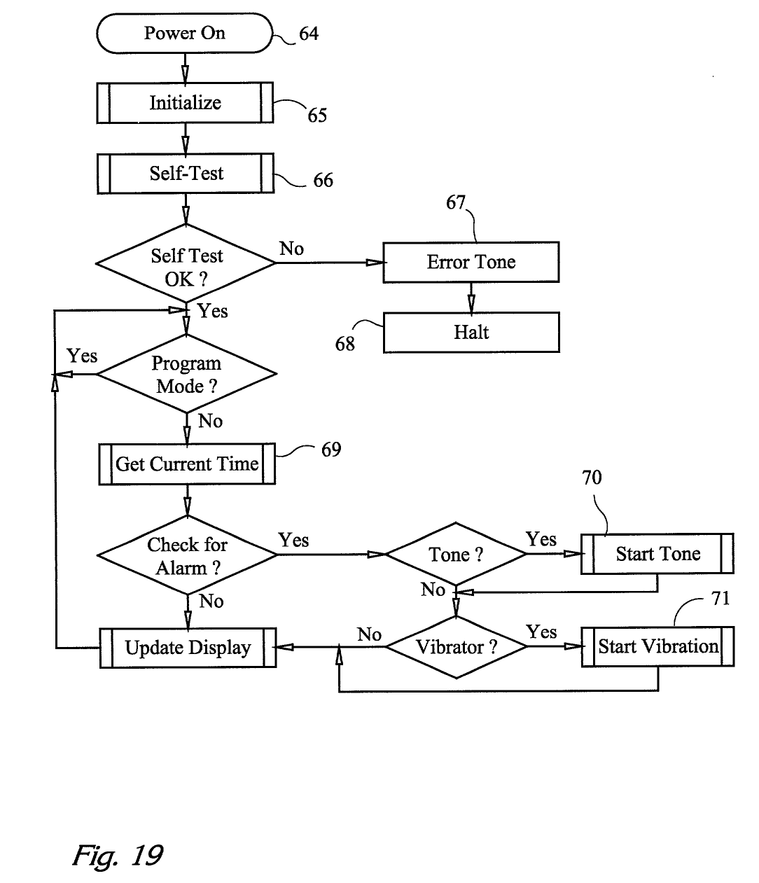

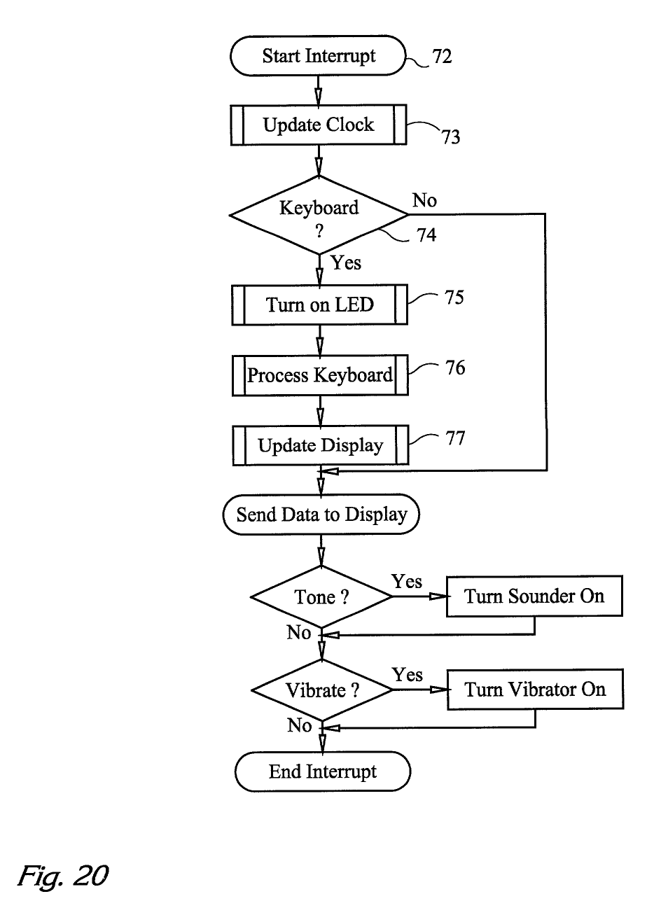

In FIGS. 19 and 20, the logical flow of the present invention can be seen. Upon successful power up at 64, the apparatus resets at 65, a listing comprised of alarm settings is queried and the data is stored in the operational buffers for processing. The apparatus performs a self-test 66 to include a RAM test, program checksum test and to check for accuracy of the crystal. If the self-test is unsuccessful, an error tone is produced 67 and the unit processing comes to a halt 68 until the error is rectified. If the unit is not in program mode, the current time is obtained at 69, and if the current time matches the alarm listing, a signal is produced, alerting the user of the current status of the unit. The alarm could be audio 70, vibration 71, visual, or combinations of the three.

The unit then initializes all interrupt routines at 72, to provide a reduced power mode and initializes the program memory. Referring to FIG. 20, the digital clock is updated at 73, and a query is sent to determine if a key has been selected 74. If it has, the LED's are illuminated for a predetermined amount of time 75, the key input is processed 76 and the digital display is updated 77 to reflect the depressed key. The audio, visual or vibration signal can be activated at this point. When the keyboard has been inactive for a predetermined length of time, the unit is placed in a reduced power mode.

The user can choose between an audio, visual or vibration alarm to signify the occurrence of an event, by depressing the appropriate key. Once the function is enabled, an appropriate icon is enabled (turned on).

This embodiment employs the same features as the preferred embodiment with respect to the messages that appear on the LCD display, informing the user which compartment contains the medicine that must be taken, how to access the compartment and when to take the medicine. Alarms are also provided here to allow the user to terminate the sounding of an alarm signal.

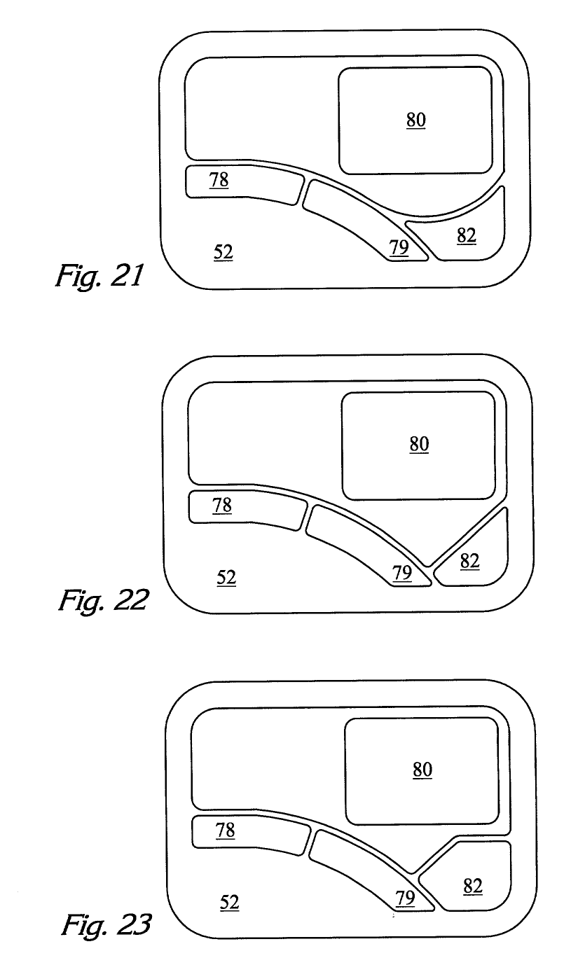

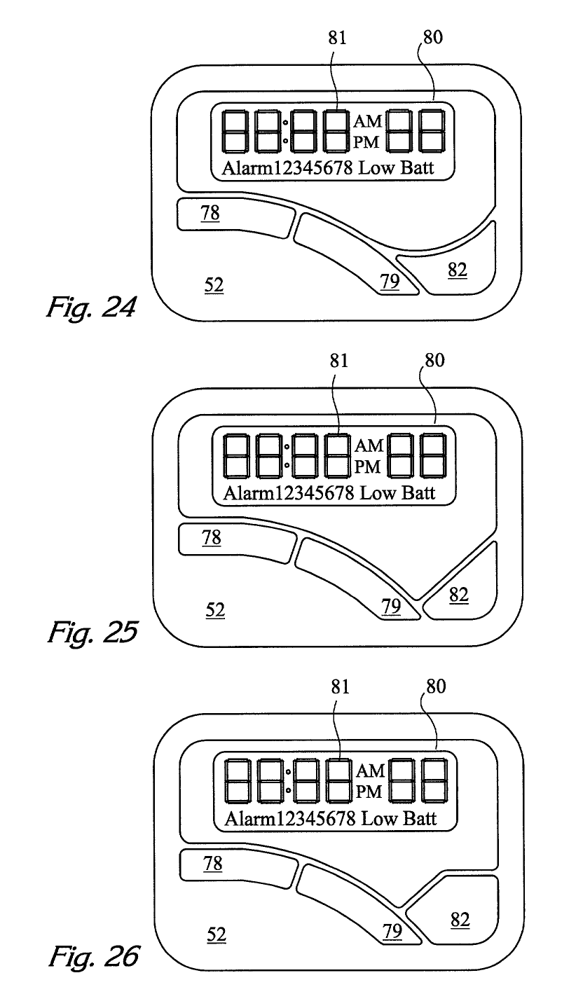

FIGS. 21-26 illustrate a few of the possible configurations of front cover 32. By depressing the function button 78, the user can toggle between modes, programming mode for entering alarm information, and normal mode, which displays the current time. Data Advance button 79 allows the user to enter alarm event information, while Acknowledgement Button 81 confirms the user's entries. Display window 80 provides a digital LCD display 81 as shown in FIG. 24-26. Display 81, when not showing the current time in normal mode, displays alarm information including which compartment contains the medicine to be taken.

Since minor changes and modifications varied to fit particular operating requirements and environments will be understood by those skilled in the art, the invention is not considered limited to the specific examples chosen for purposes of illustration, and includes all changes and modifications which do not constitute a departure from the true spirit and scope of this invention as claimed in the following claims and reasonable equivalents to the claimed elements.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. An improved pill or tablet storage, dispensing and notification apparatus designed to appear as a pager comprising:
a housing having a front cover and a back cover, said front and back cover slidably engaged with each other;
said back cover having a plurality of raised walls around its periphery creating an inner cavity;
one or more dividers removably and transversely situated within said inner cavity within said walls thereby creating a plurality of storage compartments within said housing to store said pills;
said dividers can be removed and relocated to a different position within said inner cavity thereby creating a varying of number of various-sized storage compartments;
electrical components situated within said housing, said electrical components comprising digital information display means, programmable information input means, memory storage means for recording specific events, user notification means to inform a user when a medication is to be taken, and a processing unit for controlling said digital display means, said programmable information input means, said user notification means, and said memory storage means; and
a power supply for providing power to said electrical components.

2. The storage and dispensing apparatus of claim 1 further comprising affixing means for affixing said housing to user's body, clothing or other item within the user's reach.

3. The storage and dispensing apparatus of claim 1 wherein said front cover may be slidably retracted along said back cover in order to provide a transition from a closed position where said front and back covers are substantially flush and said pills are inaccessible, to successive open positions wherein each said transition either reveals or encloses one or more said compartments and said pills therein.

4. The storage and dispensing apparatus of claim 3 wherein said front cover releasably locks into position after each said transition, and an audible click signifies said locked position.

5. The storage and dispensing apparatus of claim 1 wherein said user notification means is an audible signal.

6. The storage and dispensing apparatus of claim 1 wherein said user notification means is a vibration of said housing.

7. The storage and dispensing apparatus of claim 1 wherein said user notification means is a visual signal.

8. The storage and dispensing apparatus of claim 2 wherein said affixing means comprises an enclosure containing said housing to allow the user to secure said enclosure and said housing therein to the user's clothing or belt, said enclosure resembling a pager.

9. The storage and dispensing apparatus of claim 1 wherein said digital information display means displays information relating to the dispensing of said pills including the current time, which pills are to be taken and when, and which compartment the pills are located in.

10. The storage and dispensing apparatus of claim 1 wherein said programmable information input means is a keyboard.

11. The storage and dispensing apparatus of claim 1 wherein said memory storage means contains an alarm list comprised of time entries of when each said pill is to be taken, said processing unit compares the current time with each said alarm list time entry stored in said memory storage means and executes a command to dispense the appropriate pill if the current time matches an alarm list time entry.
